(19) United States
(12) Patent Application Publication
(10) Pub. No.: US 2017/0008021 A1
(43) Pub. Date: Jan. 12, 2017

(54) ELECTRICALLY POWERED WATER FEATURE

(71) Applicant: Simon WIGGLESWORTH, London (GB)

(72) Inventor: Simon WIGGLESWORTH, London (GB)

(21) Appl. No.: 15/113,665

(22) PCT Filed: Jan. 16, 2015
(86) PCT No.: PCT/GB2015/050090

§ 371 Date: Jul. 22, 2016

(30) Foreign Application Priority Data
Jan. 22, 2014 (GB) 1401048.2

(51) Int. Cl. B05B 17/08; H02J 7/02; B05B 9/04

(52) U.S. Cl. CPC B05B 17/08; B05B 9/0403; H02J 7/025

(57) ABSTRACT

An electrically powered water feature includes a wirelessly rechargeable power source, detachable from parts of the water feature to allow recharging thereof.

### FIELD OF THE INVENTION

The present invention relates to electrically powered water features, such as fountains, cascades and the like, particularly for indoor or garden use.

### BACKGROUND OF THE INVENTION

Electrically powered water features generally fall into two categories: mains-powered, or solar-powered. Mains-powered water features suffer from the inconvenience of requiring a mains cable connection, with associated safety issues. Solar-powered water features may be completely self-contained, but require strong sunlight to operate effectively; this renders them unsuitable for use indoors, or in countries where strong sunlight is not often available. An example of a solar-powered water feature invented by the present inventor is disclosed in WO-A-2005/011874 (Smart Solar).

In solar-powered water features, it is known to provide a battery charged by power from solar cells; this helps to even out the power supplied to a pump of the water feature, so that the pump can continue to operate for a short while when the sun is not shining. However, this does not overcome the requirements for use indoors or in countries or conditions where the sunlight is too weak.

### STATEMENTS OF THE INVENTION

According to a first aspect of the present invention, there is provided an electrically powered water feature including a wirelessly rechargeable power source, detachable from other parts of the water feature to allow recharging thereof. Thus, the water feature may be independent of the availability of the sun, without suffering the conventional disadvantages of mains power.

According to a second aspect of the present invention, there is provided apparatus for an electrically powered water or liquid feature, comprising a pump and a rechargeable power source arranged to provide power to the pump for operation of the water or liquid feature, wherein the power source includes an aperture through which the pump is arranged to pump water or liquid. Advantageously, this may allow the pump and power source to be tightly integrated.

Other aspects and optional features of the invention are defined in the claims.

### BRIEF DESCRIPTION OF THE DRAWINGS

There now follows, by way of example only, a detailed description of preferred embodiments of the present invention, with reference to the Figures identified below.

FIGs. 1a and 1b are cross-sectional and plan views respectively of a water feature according to a first embodiment of the present invention.

FIGS. 2a and 2b are cross-sectional and plan views respectively of a water feature according to a second embodiment of the present invention.

FIGS. 3a and 3b are cross-sectional and plan views respectively of a water feature according to a third embodiment of the present invention.

FIG. 4 is a schematic diagram of a rechargeable power source of any one of the embodiments, located on a charging device.

FIG. 5 is a schematic perspective view of a nozzle in any of the embodiments.

### DETAILED DESCRIPTION OF THE EMBODIMENTS

First, features common to each of the first to third embodiments will be described. The embodiments each comprise a pump 2 for pumping liquid as part of the function of the water feature, for example for pumping water through a nozzle 3 in a fountain, or pumping water to a higher level in a cascade.

Power for the pump 2 is provided by a rechargeable power source 1, such as a cell, battery or capacitor. The capacity of the rechargeable power source 1 is sufficient to power the pump for a length of time appropriate for the water feature, without requiring additional power from another source, such as a mains or solar power supply. Preferably, the rechargeable power source 1 is the sole power source for the pump 2.

Preferably, the pump 2 and rechargeable power source 1 are combined in a single, compact module that may be supplied as a component for integration into a water feature. In the specific embodiments, the rechargeable power source 1 is annular in shape, with the pump 2 arranged to pump liquid through the central aperture of the rechargeable power source 1. The pump 2 may be provided within the central aperture of the annular rechargeable power source 1. The pump 2 may be removably attached to the power source 1, with contacts provided on each to establish an electrical connection when the pump 2 and power source 1 are connected together. Preferably, the electrical connection is made waterproof, for example by one or more seals around the contacts. The removable attachment may be by means of one or more clips, detents and the like, or by an interference fit. Alternatively, the pump 2 may be completely integrated within the same, waterproof housing as the power source 1, forming an integrated, watertight module.

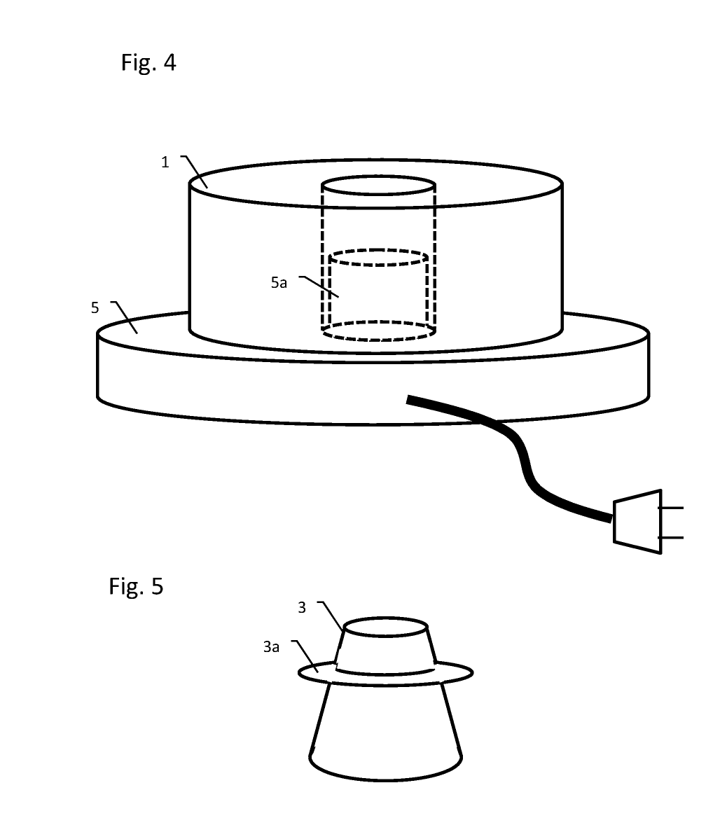

The power source 1 may be rechargeable by contactless or wireless charging, for example by inductive charging in proximity to a contactless or wireless charging device 5 connected to a source of mains power, as illustrated by way of example in FIG. 4. To achieve this, the power source 1, optionally while still connected to the pump 2, may be removed from other parts of the water feature, such as a mounting apparatus as described below, and placed in proximity to the charging device 5 for charging. After charging, the power source 1 may be reconnected to other parts of the water feature apparatus, as described below.

To enable inductive charging, the power source 1 has an inductive coil integrated therewith. The annular shape of the power source 1 facilitates the integration of a concentric annular inductive charging coil. A corresponding inductive charging coil is integrated within the charging device 5, which may be formed as a flat pad or mat on which the power source 1 rests, or may include a cylindrical peg or projection 5a on the upper surface thereof, for location within the central aperture of the annular power source 1 so as to hold the same in the correct charging position.

Alternatively, the power source 1 may be non-rechargeable, and may be detachable from the pump 2 for replacement. In another alternative, the non-rechargeable power source 1 may be integrated with the pump 2, to create a disposable module suitable for short-term use.

A controller (not shown) may be included in the module, for controlling operation of the pump 2 and/or other components. The controller may be responsive to the remote control. The controller may detect dry running of the pump 2 and interrupt the power supply to the pump 2 in response to the detection.

The nozzle 3 may be arranged to be used as a handle for easy removal of the module for recharging the power source 1, for example by inclusion of a radially projecting ring 3a as shown in FIG. 5. However, it is desirable that the nozzle 3 be removable from the module so that interchangeable nozzles 3 may be used for different water effects. To this end, the nozzle 3 is preferably removably attached to the module by a connection that cannot easily be pulled apart when the nozzle 3 is used as a handle, such as a bayonet, screw, click or clip fitting.

Each of the embodiments includes a mounting apparatus 4 allowing the pump 2 and power source 1 to be mounted within the water feature. The mounting apparatus 4 may be integrated with the module, or may be a discrete component. Further details will now be provided in the context of each embodiment in turn.

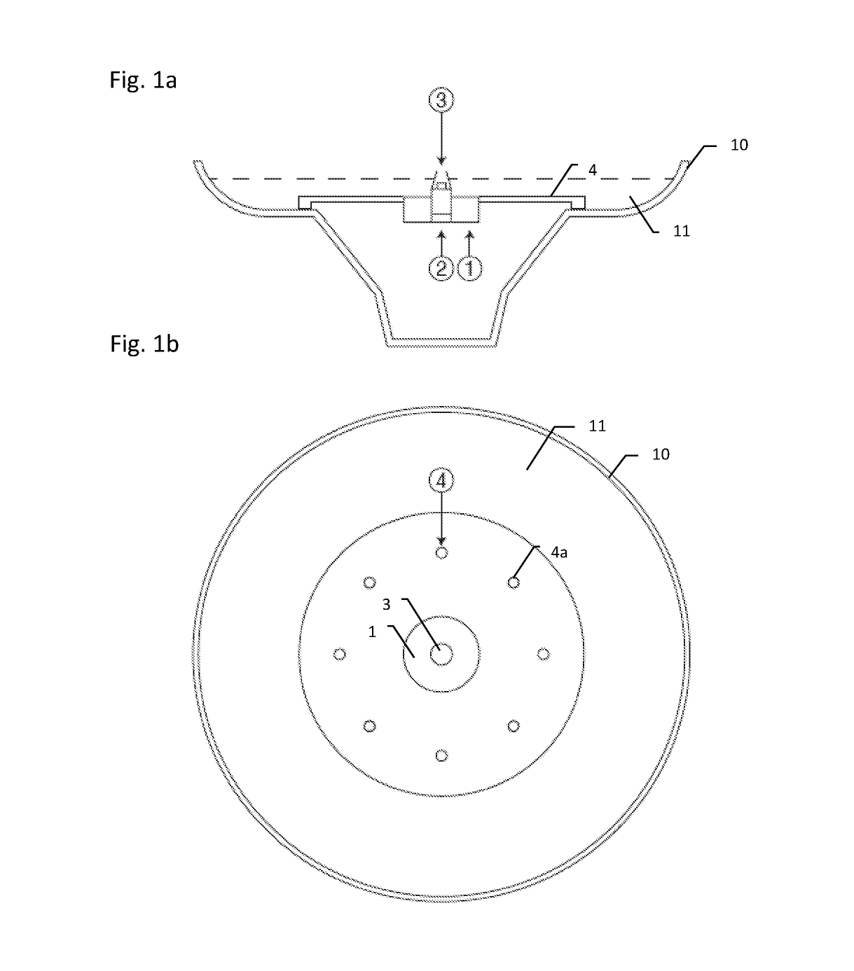

In the first embodiment shown in FIGS. 1a and 1b, the mounting apparatus 4 is arranged to mount the pump 2 and power source 1 within a water feature 10 including a reservoir 11. The mounting apparatus 4 may be arranged to provide a watertight seal against the water feature 10 so as to form the floor of the reservoir 11, in which case a liquid inlet for the pump 2 is provided above, or in the upper surface of the mounting apparatus 4, the pump 2 or the power source 1. Hence, the pump 2 and/or power source 1 are submersible. Alternatively, the mounting apparatus 4 may be liquid permeable, for example by means of apertures 4a, to allow liquid to drain through the mounting apparatus 4; in that case, a liquid inlet for the pump 2 may be provided below, or in the lower surface of the mounting apparatus 4, the pump 2 or even the power source 1.

The periphery of the mounting apparatus 4 may be removably attached to a side or bottom wall of the reservoir 11, allowing the whole assembly of mounting apparatus 4, pump 2 and power source 1 to be removed for charging and/or cleaning. Alternatively or additionally, the power source 1 and optionally the pump 2 may be removable from the mounting apparatus 4 for charging and/or cleaning.

In this embodiment the mounting apparatus 4 may be adjustable in size and/or shape to accommodate different shapes and sizes of water feature 10, for example by means of one or more legs of adjustable length. The legs may extend telescopically and/or may pivot outwardly from the power source 1. The legs may extend vertically, horizontally or at an intermediate angle. Adjustable levelling means, such as screws, may be provided as part of the mounting apparatus 4; this is important where the water feature must be precisely level, such as in a cascade. A level indicator, such as a spirit level or ball bearing level, may be included in the mounting apparatus 4 or power source 1.

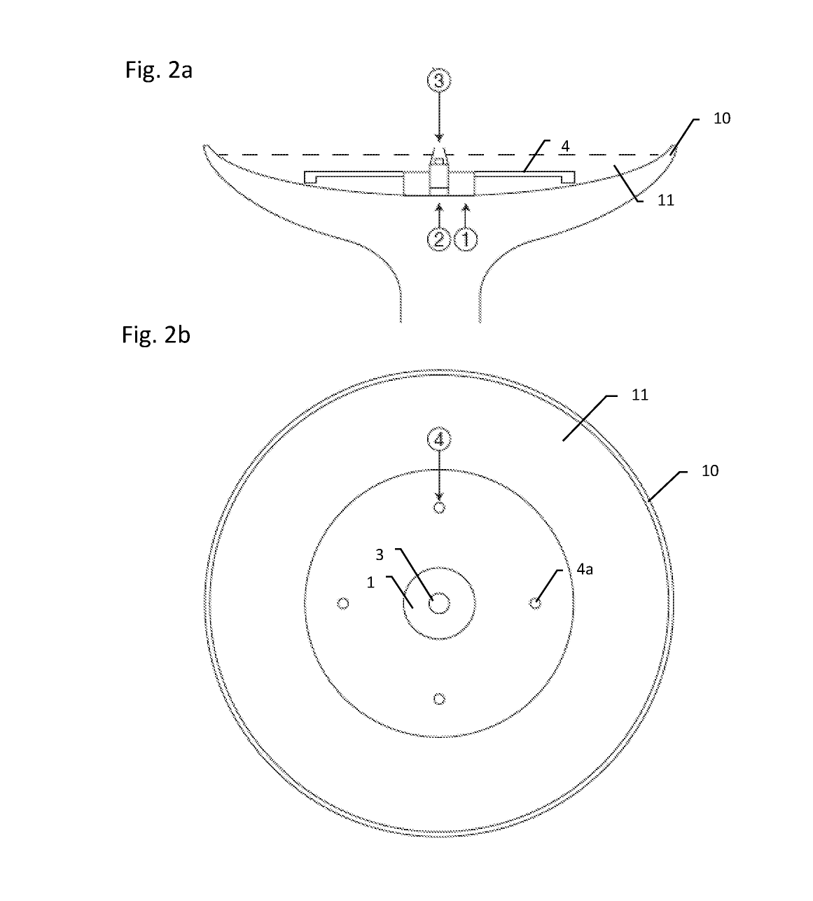

The second embodiment, as shown in FIGS. 2a and 2b, is designed for retro-fitting to a water feature 10 having an existing standard fixture; this fixture may be for a solar-powered fountain. The second embodiment differs from the first embodiment in that the mounting apparatus 4 is of fixed size and shape, for mounting on the standard fixture.

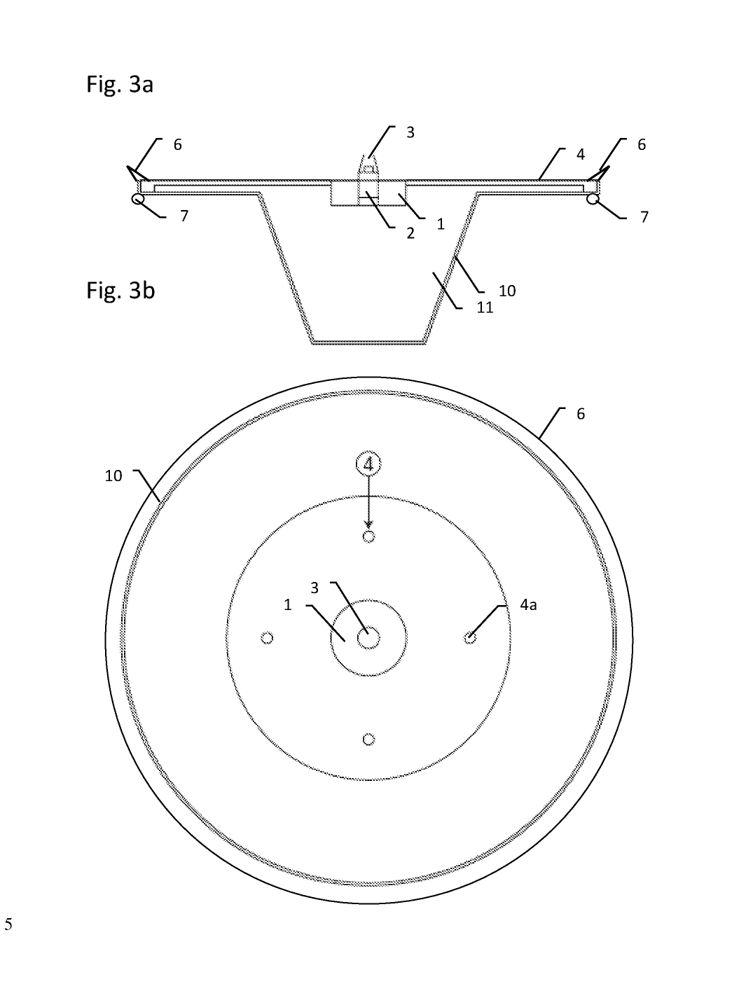

In the third embodiment, as shown in FIGS. 3a and 3b, the mounting apparatus 4 is integrated with or fixed to the reservoir 11 to form a self-contained water feature 10 that recirculates water contained within the reservoir 11. The water feature 10 may then be placed within a decorative housing, if required. One or more resilient feet 7, or a peripheral flange (not shown), may be include to provide tolerance between the water feature 10 and the decorative housing. A rim 6 may be provided around the periphery of the water feature 10, to prevent water or liquid from escaping over the periphery.

The mounting apparatus 4 may be removably attached to the top of the reservoir 11, for example by means of a screw fitting, click fitting or interference fit. Alternatively or additionally, the power source 1 may be removably attached to the mounting apparatus 4, so that the power source 1 may be recharged without removing the mounting apparatus 4.

Additional advantageous features may be added to any of the above embodiments. For example, the operation of the pump 2 may be controlled by a wireless remote control, thereby avoiding having to provide an external switch which might be hazardous or unreliable in a wet environment.

One or more light sources may be integrated with the pump 2 and/or power source 1, powered by the power source 1 and controlled by the controller, for example to illuminate the water pumped by the pump 2 and/or to provide information on the charging level of the power source 1. The light source(s) may comprise LED(s) or other suitable low-power devices. The light source(s) may be positioned to project light into the stream of water pumped by the pump 2, such that the stream of water acts as a light guide.

One or more audio output devices, such as speakers, may be integrated within the module, and powered by the power source 1. Suitable waterproof audio output devices include piezoelectric speakers. The audio output device(s) may be connected wirelessly to an audio source, for example via a Bluetooth ® connection. The audio source may be integrated with the wireless remote control for example as a smartphone app.

A misting device, such as an ultrasonic misting device, may be integrated within the module, and powered by the power source 1.

The above embodiments have been described mainly in relation to a water fountain, but aspects of these embodiments could be applied to other types of water or liquid feature, such as for example a rain effect feature using oil rather than water.

### Alternative Embodiments

The embodiments described above are illustrative of rather than limiting to the present invention. Alternative embodiments apparent on reading the above description may nevertheless fall within the scope of the invention.

1. Apparatus for an electrically powered water or liquid feature, comprising a pump (and a wirelessly rechargeable power source arranged to provide power to the pump for operation of the water or liquid feature.

2. The apparatus of claim 1, wherein the power source is detachable from another part of the water or liquid feature, to facilitate charging.

3. The apparatus of claim 2, wherein the power source is detachable from the pump.

4. The apparatus of claim 1, wherein the power source is integrated with the pump in a substantially waterproof module.

5. The apparatus of any preceding claim 1, wherein the power source includes an aperture through which the pump is arranged to pump water or liquid.

6. Apparatus for an electrically powered water or liquid feature, comprising a pump and a power source arranged to provide power to the pump for operation of the water or liquid feature, wherein the power source includes an aperture through which the pump is arranged to pump water or liquid.

7. The apparatus of claim 6, wherein the power source is rechargeable.

8. The apparatus of claim 1, including an inductive charging coil for charging the power source.

9. The apparatus of claim 1, including a wireless charging device for recharging the power source.

10. The apparatus of claim 6, wherein the power source is substantially annular.

11. The apparatus of claim 1, wherein the wireless charging device includes a protrusion for location in an aperture in the rechargeable power source.

12. The apparatus of claim 1, further comprising a mounting apparatus for mounting the pump and power source within the water or liquid feature.

13. The apparatus of claim 12, wherein the mounting apparatus allows water or liquid to pass therethrough.

14. The apparatus of claim 12, wherein the mounting apparatus is adjustable in size and/or shape so as to allow mounting of the pump and power source within water or liquid features of different sizes and/or shapes.

15. The apparatus of claim 14, wherein the mounting apparatus is adjustable so as to level the apparatus.

16. The apparatus of claim 12, wherein the pump and/or power source is removably attachable or attached to the mounting apparatus.

17. The apparatus of claim 12, including a reservoir connectable to or connected to the mounting apparatus such that the pump is able to pump water or liquid from the reservoir.

18. The apparatus of claim 1, including a peripheral rim arranged to inhibit the escape of water or liquid.

19. The apparatus of claim 1, including resilient means for providing tolerance in a fit between the apparatus and the water or liquid feature.

20. The apparatus of claim 19, wherein the resilient means comprises one or more resilient feet or a flange.

21. The apparatus of claim 1, including a detachable nozzle arranged to be usable as a handle.

22. The apparatus of claim 21, wherein the detachable nozzle is attached by means of a bayonet, screw, click or clip fitting.

23. The apparatus according to claim 21, wherein the nozzle includes a radial projection enabling the nozzle to be used as a handle.

24. The apparatus of claim 1, including a controller for controlling operation of the pump and/or other components of the apparatus.

25. The apparatus of claim 24, wherein the controller is controllable by wireless remote control device.

26. The apparatus of claim 24, wherein the controller is arranged to inhibit dry running of the pump.

27-30. (canceled)
